(19) United States
(12) Patent Application Publication
(10) Pub. No.: US 2005/0105666 A1
(43) Pub. Date: May 19, 2005

(54) Production of thorium-229

(76) Inventors: Saed Mirzadeh, Knoxville, TN (US); Marc Alan Garland, Columbia, SC (US)

Correspondence Address: AKERMAN SENTERFITT, P.O. BOX 3188, WEST PALM BEACH, FL, 33402-3188, US

(21) Appl. No.: 10/938,044

(22) Filed: Sep. 10, 2004

Related U.S. Application Data
(60) Provisional application No. 60/503,149, filed on Sep. 15, 2003.

(51) Int. Cl. G21G 1/10

(52) U.S. Cl. 376/198

(57) ABSTRACT

A method for producing ²²⁹Th includes the steps of providing ²²⁶Ra as a target material, and bombarding the target material with alpha particles, helium-3, or neutrons to form ²²⁹Th. When neutrons are used, the neutrons preferably include an epithermal neutron flux of at least 1×10¹³ n s⁻¹·cm⁻². ²²⁸Ra can also be bombarded with thermal and/or energetic neutrons to result in a neutron capture reaction to form ²²⁹Th. Using ²³⁰Th as a target material, ²²⁹Th can be formed using neutron, gamma ray, proton or deuteron bombardment.

### CROSS-REFERENCE TO RELATED APPLICATIONS

This application claims the benefit of U.S. Provisional Application No. 60/503,149 entitled Process For Production of Thorium-229 filed on Sep. 15, 2003, the entirety of which is incorporated herein by reference.

### FIELD OF THE INVENTION

The invention relates to methods for producing thorium-229.

### STATEMENT REGARDING FEDERALLY SPONSORED RESEARCH OR DEVELOPMENT

The United States Government has rights in this invention pursuant to Contract No. DE-AC05-00OR22725 between the United States Department of Energy and UT-Battelle, LLC.

### BACKGROUND OF THE INVENTION

The goal in the treatment of cancerous tumors and micrometastases has long been to kill the cancerous cells without killing healthy cells. Today, in the development of new short-range, site-specific therapies, there is increasing interest in using radioisotopes which decay with the emission of alpha particles. Indeed, recent clinical trials have shown the effectiveness of the alpha-emitter bismuth-213 in killing cancer cells in patients with acute myeloid leukemia. In addition, lung tumors in mice have been effectively treated for the first time by using an antibody radiolabeled with bismuth-213, targeting the lung vascular endothelial cells.

Alpha-particles are of interest in site-specific therapy because of their short range. Bismuth-213 emits an 8 MeV alpha particle which penetrates only 6 to 10 cell layers nearby, killing the cells in its short path (˜80 μm), including cancer cells. In addition to bismuth-213, there are only eight other known alpha-emitters with potential for this type of application, namely, astatine-211, bismuth-212, lead-212, radium-223, radium-224, radium-225, actinium-225, and fermium-255.

There are a number of factors that need to be considered in using any radioisotope in humans, especially those radioisotopes emitting alpha particles. These factors include availability, cost, nuclear characteristics, chemistry, and in vitro and in vivo stability of the biomolecules labeled with alpha-emitters. The first two alpha-emitters to be used in human trials are bismuth-213 and astatine-211; the other seven radioisotopes mentioned above are under more preliminary investigations. Bismuth-213 is currently being used in human trials at Memorial Sloan-Kettering Cancer Center (New York) and is generated in-house from the decay of actinium-225. This radioisotope is produced from the decay of radium-225, which is the daughter of thorium-229, which, in turn is the alpha decay daughter of uranium-233.

Currently, uranium-233 is the only viable source for high purity thorium-229. However, the anticipated growth in demand for actinium-225 may soon exceed the levels of thorium-229 present in the aged uranium-233 stockpile (in fact, there have been occasions that supply has not been able to keep up with the current demand). It is estimated that only ˜45 g or ˜9 curies of thorium-229 (²²⁹Th specific activity is 0.2 mCi/mg) can be extracted from entire uranium-233 stockpile at the Oak Ridge National Laboratory (hereinafter “ORNL”). The uranium-233 stockpile at ORNL is about 50% of the high quality uranium-233 available in the world which provides reasonably low quantities of both Th-228 and Th-232. This stockpile is only about eighty times the current thorium stock. Large quantities of Th-228 or Th-232 can make the use of a uranium-233 stockpile impractical. Considering the rather low annual production rate of thorium-229 from uranium-233 (0.92 mCi/kg) and the increasing difficulties associated with uranium-233 safeguards, large-scale routine processing of uranium-233 is, at a minimum, problematic.

A number of approaches have been identified as alternative routes for the production of ²²⁹Th(t_{1/2}=7340 y), or for direct production of ²²⁵Ra(t_{1/2}=15 d), and ²²⁵Ac(t_{1/2}=10 d). These approaches include a) production of ²²⁹Th in a nuclear reactor by thermal neutron transmutation of ²²⁶Ra targets, b) direct production of ²²⁵Ac from proton and deuteron irradiation of ²²⁶Ra targets via the [p,2n] and [d,3n] reactions, respectively, at accelerators, and c) indirect production of ²²⁵Ac from the decay of ²²⁵Ra which in turn is produced by high energy γ-ray irradiation of a ²²⁶Ra target, [γ,n] reactions. The alternate route (a) noted above produces a low yield of ²²⁹Th.

### SUMMARY OF THE INVENTION

A method for producing ²²⁹Th includes the steps of providing ²²⁶Ra as a target material, and bombarding the target material with alpha particles, helium-3, or neutrons to form ²²⁹Th. When the energetic particles comprise neutrons, the neutrons preferably include an epithermal neutron flux of at least 1×10¹³ n s⁻¹·cm⁻². When alpha particles are used an energy of the alpha particles can be between 15 MeV and 25 MeV, such as about 20 MeV, and when helium-3 particles are used an energy of the helium-3 particles can be 8 MeV to 20 MeV, such as about 16 MeV.

A method for producing ²²⁹Th includes the steps of providing ²²⁸Ra as a target material, and bombarding the target material with neutrons to produce a neutron capture reaction of the ²²⁸Ra to form ²²⁹Th. The neutrons can be thermal and/or epithermal neutrons.

In another embodiment of the invention, a method for producing ²²⁹Th includes the steps of providing ²³⁰Th as a target material, and bombarding the target material with energetic particles to form ²²⁹Th. The energetic particles can comprise neutrons sufficient to result in a ²³⁰Th[n,2n]²²⁹Th reaction to form ²²⁹Th. The energetic particles can comprise gamma rays having energies sufficient to result in ²³⁰Th[γ,n]²²⁹Th reaction to form ²²⁹Th, such as having an energy of from 8 MeV to about 12 MeV. The energetic particles can comprise protons or deuterons having energies sufficient to result in ²²⁹Pa, the ²²⁹Pa decaying or transmuting into ²²⁹Th. When protons are used, the energy of the protons can be from 8 MeV to about 16 MeV. When deuterons are used, the energy of the deuterons can be from 16 MeV to about 28 MeV.

### BRIEF DESCRIPTION OF THE DRAWINGS

There are shown in the drawing embodiments which are presently preferred, it being understood, however, that the invention can be embodied in other forms without departing from the spirit or essential attributes thereof.

FIG. 1 shows the neutron capture cross sections for the irradiation of radium-226 with an accompanying table below summarizing the data.

### DETAILED DESCRIPTION OF THE INVENTION

The invention provides methods for the production of thorium-229. The methods have good yields and generally lower contamination levels as compared to known methods for production of thorium-229 other than by decay of U-233.

In a first embodiment, thorium-229 is produced via alpha particle bombardment of a radium-226 target, such as using a cyclotron. Radium-226 is a by-product of uranium processing and significant quantities of ²²⁶Ra can be readily made available if a use for this isotope is identified. The amount of ²²⁶Ra in naturally occurring uranium is about 0.33 g per ton of uranium.

No excitation function for the ²²⁶Ra[α,n]²²⁹Th reaction is currently known. However, from the excitation functions known for ²⁰⁹Bi[α,xn] reactions, a threshold energy of about 8 MeV can be expected, and a maximum cross section of ˜2 barns at 15 MeV. From systematics, the optimum incident energy of alpha particles for this reaction is about 20 MeV, and the maximum cross section for [α,n] is expected to be at least tenfold larger than that of the [p,n] reaction. The above assumptions translate to a production rate of ˜1 μCi of ²²⁹Th per day at a 20 μA current of alpha particles with incident energy of ˜20 MeV. By preferably controlling the incident α-particle energy just below the threshold of the [α,2n] reaction which is about 20 MeV, the production of unwanted ²²⁸Th can be minimized. For example, the energy of the alpha particles can be 15 to about 20 MeV, such as about 16 MeV.

The excitation function is preferably obtained to permit fine adjustment of the incident alpha particle energy such that the ²²⁹Th yield is maximized and ²²⁸Th contamination level is minimized. Very thin targets of ²²⁶Ra (1-2 μg/cm² by electrodeposition) can be used for excitation function measurements by a stacked foil technique. Preparation of very thin targets of ²²⁶Ra (1-2 μg/cm²) by the electrodeposition method is known. Carrier-free ²²⁶Ra can be electroplated on Pt foil from 0.1 M HNO₃ under 8 volt of direct current. Yields of better than 80% have been obtained within 2 hours. Modification of this procedure could be used for preparation of thin targets of ²²⁶Ra using high purity Al foils having a thickness of about 0.1 mm. Each Ra deposited foil can then be covered with another Al foil and sealed by epoxy. The Al foils serve as energy degraders. For the excitation function measurements, the irradiation time could be limited to 10-60 minutes at a current of ˜1 μA. The incident alpha particle energy will be about 20 MeV. Under these conditions, the level of activity in target foils will range from 0.1-1 pCi of ²²⁹Th per foil. After irradiation, the target will be allowed to cool for several days, then will be analyzed by gamma-ray spectroscopy.

Thorium-229 emits two predominant gamma rays at 193 and 213 keV with intensities. of 4.4 and 3.0%, respectively. At equilibrium with its daughter products, however, more intense gamma rays from 4.8-min ²¹⁸Fr at 218 keV (11.6%) and from 46.5-min ²¹³Bi at 440 keV (26.1%) can be used for quantitation of ²²⁹Th. Accordingly, about 100 days should be allowed for 99.9% equilibrium. Th-228 can be quantitated by measuring the activity of ²¹²Pb and ²¹²Bi at 238 keV (43.9%) and 583 keV (31.1%), respectively. Th-228 reaches equilibrium within two weeks.

It is anticipated that both ²²⁶Ra and ²²⁹Th undergo fission during alpha bombardment or indirectly by secondary neutrons. The expected fission cross sections are rather small and in the millibarn (mb) range.

Helium-3 (³He) bombardment can be used instead of alpha (⁴He or α) particle bombardment to produce thorium-229 from radium-226. The reaction in this case would be ²²⁶Ra[³He, γ]²²⁹Th, with a threshold of about 8 MeV, but the maximum of the cross-section is expected to be about ten fold smaller than α-induced reaction, and thus about a ten fold lower yield. As in the case of alpha particle bombardment, excitation functions for this and competing reactions are not currently known.

In another embodiment of the invention, thorium-229 is produced via multiple-neutron capture by a radium-226 target in the epithermal region. A known approach for the production of ²²⁹Th is by thermal neutron irradiation of a radium-226 target in a reactor. This approach consists of a number of neutron captures and beta decays. As it implies, the thermal cross section is the probability of interaction of a nuclide with thermal neutrons while the resonance integral is the probability of interaction of the same nuclide with higher energy (epithermal) neutrons.

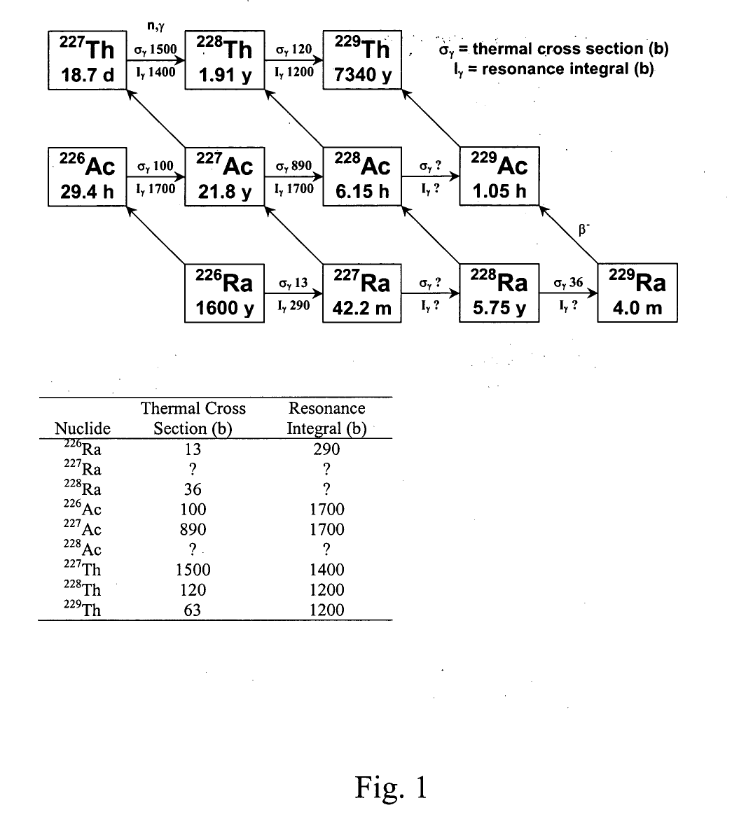

FIG. 1 shows neutron capture cross sections for the irradiation of radium-226 with the accompanying table below summarizing the data. In all the pathways shown leading to ²²⁹Th starting from a ²²⁶Ra target, the resonance integrals are far greater (in some cases an order of magnitude greater) than the thermal cross sections. For example, neutron capture by ²²⁶Ra has a thermal cross section of 13 b while the resonance integral is 290 b, more than an order of magnitude greater.

Thus, production of ²²⁹Th from neutron irradiation of a ²²⁶Ra target is much more efficient with higher energy neutrons as compared to irradiation with thermal neutrons. It is estimated that the contribution of epithermal neutrons to the total yield of ²²⁹Th is 99.2% in the case where a ²²⁶Ra target is irradiated in the core of a high flux isotope reactor (i.e., production due to thermal neutrons is only 0.8% of the total). Accordingly, much more ²²⁹Th can be produced by epithermal neutrons than using conventional thermal neutrons.

The most common sources of epithermal neutrons are research nuclear reactors. For example, in the flux trap region of the High Flux Isotope Reactor (HFIR) at ORNL, the epithermal neutron flux per unit lethargy is greater than 1×10¹³ n s⁻¹·cm⁻² (generally ranging from 2×10¹³ to 8×10¹³ n s⁻¹·cm⁻²). Note that lower neutron fluxes will generally be of little use for this approach, because a 10 fold lower neutron flux results in ˜1000-fold reduction in the ²²⁹Th yield. Alternatively, epithermal neutrons can be produced by slowing down fast neutrons available from charged particle accelerators where the fast neutrons are generated through a number of nuclear reactions such as fusion, fission, pick-up, spallation reactions, and others.

The significance of the contribution of epithermal neutrons to the total reaction rate, which is disclosed herein, can also be extended to the production of thorium-228 (and its daughters radium-224, lead-212, bismuth-212, and other daughter isotopes in this decay chain) and actinium-227 (and its daughters radium-223, and other daughter isotopes in this decay chain), two other radionuclides which may also prove useful for medical applications. It is noted that radium-226 is the target for the production of thorium-228 and actinium-227.

In another embodiment, thorium-229 can be produced via a neutron capture reaction of radium-228. Radium-228 with a half-life of 5.75 y, is the first alpha decay product of naturally occurring thorium-232, and can be made available through the chemical processing of natural thorium. The amount of ²²⁸Ra in 30-y old thorium is about 0.4 mg per ton of thorium.

The reported cross section for neutron capture of radium-228, ²²⁸Ra[n,γ] ²²⁹Ra is about 36 barns for thermal neutrons available from nuclear reactors. The cross section for epithermal neutrons is not currently known. The product of ²²⁸Ra neutron capture, ²²⁹Ra, has a half-life of only 4 min and decays with 100% β⁻ to 62.7-min ²²⁹Ac, which in turn decays with 100% β⁻ to ²²⁹Th. At a thermal neutron flux of 1×10¹⁵ n/s·cm², the yield of ²²⁹Th from ²²⁸Ra[n,γ]²²⁹Ra(β⁻, t_{1/2}=4 min) ²²⁹Ac(β⁻, t_{1/2}=1 hour)²²⁹Th reaction is about 27 mCi per gram of ²²⁸Ra for one-year irradiation. The main advantage of this reaction will be higher yield of ²²⁹Th relative to other reactions, and significantly lower contamination with ²²⁸Th, and almost no contamination from ²²⁷Ac. The main disadvantage of this reaction is the relatively short half-life of the target material and its availability.

In another embodiment, thorium-229 is produced via neutron bombardment of a thorium-230 target. Thorium-230 with a half-life of 7.5×10⁴ y, is a part of the uranium-238 decay chain, and depending on the geological location the amount of ²³⁰Th in uranium mines is about 16 g per ton of uranium.

The ²³⁰Th[n,2n]²²⁹Th reaction has a threshold energy of 6.8 MeV and a cross section of 1.34 barns at 14 MeV. These assumptions translate to a production rate of ˜2.5 nCi of ²²⁹Th per day per gram of ²³⁰Th at neutron flux of 10¹¹ n s⁻¹·cm⁻² with an energy of 14 MeV. The 14 MeV neutrons can be produced in a cyclotron through a number of nuclear irradiations, the most common being the irradiation of a Be target with deuterons having an energy of ˜30 MeV, generating a neutron flux of 3×10¹⁰ n.s⁻¹.μA⁻¹ at 0-20° solid angle. For a 10 μA deuteron beam, the total neutron flux in the forward direction would be ˜3×10¹¹, distributed over an area ˜2 cm². By controlling the incident deuteron energy below ˜35 MeV, production of higher energy neutrons (>20 MeV) will be substantially minimized, and hence the production of unwanted ²²⁸Th which is produced via ²³⁰Th[n,3n]²²⁸Th can be substantially reduced. It is noted that the threshold for the ²³⁰Th[n,3n]²²⁸Th reaction is about 12 MeV. As noted above, high energy neutrons can be obtained from reactors such as High Flux Isotope Reactors. Alternatively, 14 MeV neutrons can be readily obtained from D-T fusion reactions. Also, high energy neutrons can be produced in charged particle accelerators via fission, fision, pick-up, spallation, and other reactions.

Alternatively, high-energy neutrons available from a nuclear reactor can be used, where the flux of neutrons with energy >7 MeV is on the order of 5×10¹³ n s⁻¹·cm⁻². The fission averaged cross section of ²³⁰Th[n,2n]²²⁹Th reaction is 10.66 mb. The yield of ²²⁹Th from reactor irradiation of ²³⁰Th would be on the order of 10 nCi per gram of target per day or 3.7 μCi per gram per year of irradiation. The main disadvantage of the ²³⁰Th[n,2n]²²⁹Th reaction would be the generation of fission products as the fission averaged cross section of ²³⁰Th is rather significant (163 mb).

In another embodiment, thorium-229 is produced via gamma ray bombardment of a thorium-230 target via the ²³⁰Th, [γ,n] reaction. No excitation function for the ²³⁰Th[γ,n]²²⁹Th reaction is currently known. However, from the reported excitation functions for ²³²Th[γ,n] reactions, a threshold energy of ˜6 MeV can be expected, and a maximum cross section of ˜440 millibarns at ˜11.5 MeV. The maximum incident energy of the incident gamma ray for this reaction is about 12 MeV in order to minimize the production of unwanted ²²⁸Th by the ²³⁰Th[γ,2n]²²⁹Th reaction. Production of ²³¹Th via the ²³²Th[γ,n] reaction is known to be 22 mCi/h/g of ²³²Th in a 10 kW electron accelerator producing 25 MeV electrons. If ²²⁹Th is produced from ²³⁰Th at the same rate, the product activity of ²²⁹Th will be 0.21 μCi/d/g of 230Th.

In another embodiment, thorium-229 is produced via proton and deuteron irradiation of thorium-230 targets, such as in an accelerator. Both reactions are believed to actually proceed through production of relatively short-lived protactinum-229 having a half life of only 1.5 day, ²³⁰Th [p,2n]²²⁹Pa(EC,t_{1/2}=1.5 d) ²²⁹Th and ²³⁰Th [d,3n]²²⁹Pa(EC,t_{1/2}=1.5 d) ²²⁹Th reactions, respectively. No excitation functions for these reactions are reported. In the case of the proton-induced reaction, from the reported excitation function for a similar reaction using a thorium-232 target, ²³²Th[p,2n] reaction, a threshold energy of ˜10 MeV can be expected, a maximum cross section of ˜400 millibars at ˜15 MeV, and a cross section of ˜200 mb at 20 MeV. However, in order to minimize the production of unwanted ²²⁸Th by the ²³⁰Th[p,3n]²²⁸Pa(EC,t_{1/2}=22 h)²²⁸Th reaction, the maximum energy of the incident proton used for this reaction is limited to about 16 MeV. Assuming an average cross section of 200 mb, bombarding a foil of ²³⁰Th with a thickness of 0.5 mm (˜0.55 g/cm², range of protons 16→10 MeV) translates to a production rate of ˜0.6 μCi of ²²⁹Th per day at a 100 μA current of protons with an incident energy of 16 MeV.

In the case of the deuteron-induced reaction, from the reported excitation functions of for a similar reaction using a bismuth-209 target, ²⁰⁹Bi[d,3n] reaction, a deuteron threshold energy of ˜16 MeV can be extrapolated. Above the threshold, the cross section sharply increases to a maximum of ˜1.5 barn, then drops off rapidly to ˜500 mb at 32 MeV. The maximum energy of the incident deuteron for this reaction is about 28 MeV, in order to reduce the probability of the evaporation of an additional neutron which results in the production of unwanted ²²Th by the ²³⁰Th[d,4n]²²⁸Pa(EC,t_{1/2}=22 h)²²⁸Th reaction. In this case, assuming an average cross section of 700 mb, bombarding a foil of ²³⁰Th with a thickness of 0.7 mm (˜0.78 g/cm², range of deuterons 28→16 MeV) results in a production rate of ˜3 μCi of ²²⁹Th per day at a 50 μA current of deuterons with an incident energy of 28 MeV.

The necessary fast turn-around for processing of the Ra target in the direct production of ²²⁵Ra and ²²⁵Ac (a few days post-irradiation) is the main disadvantage for proton, deuteron and gamma ray irradiation of a radium target via ²²⁶Ra[p,2n]²²⁵Ac, ²²⁶Ra[p,pn]²²⁵Ra(t_{1/2}=15 days, β⁻)²²⁵Ac, or ²²⁶Ra[γ,n]²²⁵Ra(t_{1/2}=15 days, β⁻)²²⁵Ac reactions. The main drawback in the reactor approach for the production of ²²⁹Th using a ²²⁶Ra target is the significant contamination of ²²⁹Th with ²²⁸Th(t,_{1/2}=2.8 y) that generally results. The approaches for production of ²²⁹Th via alpha or ³He bombardment of a radium-226 target described above generally provides thorium-229 with significantly reduced levels of ²²⁸Th contamination. The fast neutron irradiation of a thorium-230 target, or neutron capture by ²²⁸Ra generally also provides thorium-229 with significantly reduced levels of ²²⁸Th contamination as compared to the reactor approach using a ²²⁶Ra target.

The thorium-229 generated using the invention must be separated from the target material and other by-products generated for most uses. Radiochemical procedures can be used for the separation of thorium-229 from target materials and by-products. The chemical processing of U, Th, Ac and Ra has been studied extensively in the past 70 years and is well known. In summary, after irradiation, the target can be dissolved and Th selectively retained on anion exchange resin (e.g. MP1 resin, BioRad Inc.) from 7.5 M HNO₃ as the Th(NO₃)₆²⁻ complex, while U(VI), Ac(III), Fe(III), Al(III), Ra(II) and Pb(II) and a number of fission products are eluted. Subsequent to the elution of Th from the column with O.1 M HNO₃, the Th is further purified by hydroxide precipitation in the presence of the Fe⁺³ carrier to eliminate Tc and I. Thorium is then separated from the Fe⁺³ carrier by retaining FeCl₄⁻ on an anion exchange column in 10 M HCl. After allowing ²²⁵Ra and ²²⁵Ac to reach their equilibrium values (˜45 days), they are separated from Th using anion exchange resin and 7.5 M HNO₃ as described above. Separation of Ac from Ra is accomplished by one of two methods, both based on cation exchange resin from nitric acid media. In the first method, using 1.2 M HNO₃ as eluent, Ra⁺² is eluted ahead of Ac⁺³ with a small overlap. When the eluent is changed to 0.15 M NH₄Cl and 0.1 M NaEDTA, pH ˜5, (the second method), Ac is eluted quantitatively whereas Ra remains adsorbed on the resin (reverse phase chromatography). Both methods have been tested extensively for the separation of carrier-free ²²⁵Ac from ²²⁴Ra and ²²⁵Ra and they work well.

Thorium-229 produced using the invention is expected to be used for a variety of medical applications, such as for killing cancer cells. With appropriate biological targeting molecules, bismuth-213 can be used not only in cancer therapy but also for autoimmune diseases, organ transplantations, bone marrow ablations, and vasculature irradiation following restenosis.

For example, the invention can be used for cell-directed radiation therapy. In this method, millions of cancer seeking antibodies guide radiation to the cancer. Energetic radioactive isotopes (radioisotopes which are capable of depositing a significant amount of energy in a short distance in the tissue) according to the invention are attached to the antibodies. As the cancer hunting antibodies flow though the blood stream, the radioactive isotopes ride along. The antibodies target cell surface binding sites specific to the cancer cells. When the antibodies reach a cancer cell, they attach. Radiation from these bound radioisotopes then destroys the cancer cells that make up the malignant tumor.

This invention can be embodied in other forms without departing from the spirit or essential attributes thereof and, accordingly, reference should be had to the following claims rather than the foregoing specification as indicating the scope of the invention.

1. A method for producing ²²⁹Th, comprising the steps of:
providing ²²⁶Ra as a target material, and bombarding said target material with energetic particles selected from neutrons, alpha particles and helium-3 particles to form ²²⁹Th.

2. The method of claim 1, wherein said energetic particles comprise neutrons, said neutrons having an epithermal neutron flux of at least 1×10¹³ n s⁻¹·cm⁻².

3. The method of claim 1, wherein said energetic particles comprise said alpha particles or said helium-3 particles.

4. The method of claim 3, wherein said alpha particles are used and an energy of said alpha particles is between 15 MeV and 25 MeV or said helium-3 particles are used and an energy of said helium-3 particles is between 8 MeV and 20 MeV.

5. A method for producing ²²⁹Th, comprising the steps of:
providing ²²⁸Ra as a target material, and bombarding said target material with at least one of thermal and epithermal neutrons to produce a neutron capture reaction of said ²²⁸Ra to form ²²⁹Th.

6. A method for producing ²²⁹Th, comprising the steps of:
providing ²³⁰Th as a target material, and bombarding said target material with energetic particles to form ²²⁹Th.

7. The method of claim 6, wherein said energetic particles comprise neutrons sufficient to result in a ²³⁰Th[n,2n]²²⁹Th reaction to form ²²⁹Th.

8. The method of claim 6, wherein said energetic particles comprise gamma rays having energies sufficient to result in ²³⁰Th[γ,n]²²⁹Th reaction to form ²²⁹Th.

9. The method of claim 8, wherein an energy of said gamma rays is from 8 MeV to 12 MeV.

10. The method of claim 6, wherein said energetic particles comprise protons or deuterons having energies sufficient to result in ²²⁹Pa, said ²²⁹Pa decaying or transmuting into ²²⁹Th.

11. The method of claim 10, wherein said protons are used, an energy of said protons being from 8 MeV to 16 MeV.

12. The method of claim 10, wherein said deuterons are used, an energy of said deuterons being from 16 MeV to 28 MeV.
